(19) United States
(12) Patent Application Publication
(10) Pub. No.: US 2025/0328770 A1
(43) Pub. Date: Oct. 23, 2025

(54) TARGET PROPERTY SELECTION TECHNIQUES FOR LEARNING WHAT TO TEACH LANGUAGE MODELS FOR CODE GENERATION

(71) Applicant: Microsoft Technology Licensing, LLC, Redmond, WA (US)

(72) Inventors: Gust VERBRUGGEN, Keerbergen (BE); Sumit GULWANI, Sammamish, WA (US); Mukul SINGH, Delhi (IN); Vu Minh LE, Redmond, WA (US); Anirudh Vishal KHATRY, Mumbai (IN)

(73) Assignee: Microsoft Technology Licensing, LLC, Redmond, WA (US)

(21) Appl. No.: 18/638,569

(22) Filed: Apr. 17, 2024

(51) Int. Cl. G06N 3/0895; G06F 40/35

(52) U.S. Cl. CPC G06N 3/0895; G06F 40/35

(57) ABSTRACT

A data processing system implements extracting symbolic property information from a training dataset by analyzing the training dataset with a symbolic property mining pipeline to extract properties of program code from one-shot program code examples, the symbolic property information indicative of types of properties of the one-shot program code examples determined to improve program code output by a large language model (LLM) in response to natural language utterances; and training a property recognition model to recognize symbolic properties associated with a natural language utterance using the training dataset and the symbolic property information, the property recognition model being configured to analyze the natural language utterance and to output the symbolic properties of program code.

### BACKGROUND

In-prompt learning enables large language models (LLMs) to learn from information in the prompt. Examples of in-prompt learning includes one-shot learning and few-shot learning. One-shot learning involves providing a single labeled example with the prompt to the LLM, while few-shot learning includes several examples with the prompt to the LLM. In-prompt learning is commonly used in code generation from natural language utterances to teach the LLM specific syntax or to teach the LLM how to use specific functions by providing the LLM with relevant examples. Determining the relevance of these examples is a critical challenge. Sentence embeddings are commonly used to select examples. The embeddings may be used in their raw form, fine-tuned towards similarity to associated code snippets, or based on a paraphrased utterance that highlights required capabilities. However, such techniques are unsupervised and make strong assumptions about what it means to be a good example such as having similar utterances or having similar code. Other approaches take a probabilistic approach that rely on token probabilities, but these probabilities are often unavailable. Furthermore, both the similarity and probabilistic approaches share a common problem. It is unknown whether relevant parts of the utterance and code are causing high similarities or probabilities, and it is unknown how many examples to pick to provide to the LLM. Hence, there is a need for improved systems and methods that provide means for selecting relevant examples for one-shot and/or few-shot learning techniques.

### SUMMARY

An example data processing system according to the disclosure includes a processor and a memory storing executable instructions. The instructions when executed cause the processor alone or in combination with other processors to perform operations including accessing a datastore of training data to obtain a training sample, the training sample comprising a natural language utterance, ground truth program code, and a one-shot program code example, the natural language utterance requesting that an application perform one or more actions, the ground truth program code providing an example of program code which implements an intent expressed in the natural language utterance, and the one-shot program code example is to be assessed to determine whether the one-shot program code example improves predicted program code output by a language model in response to the natural language utterance; constructing a first prompt based on the natural language utterance; providing the first prompt as an input to the language model to cause the language model to generate a zero-shot prediction, the zero-shot prediction comprising first program code generated by the language model in response to the first prompt; constructing a second prompt based on the natural language utterance and the one-shot program code example; providing the second prompt as an input to the language model to cause the language model to generate a one-shot prediction, the one-shot prediction comprising second program code generated by the language model in response to the second prompt; comparing the zero-shot prediction, the one-shot prediction, and the ground truth program code to determine a delta value indicative of whether the one-shot prediction is more similar to the ground truth program code than the zero-shot prediction; analyzing the natural language utterance to generate first embeddings; analyzing the one-shot program code example to generate second embeddings; analyzing the first embeddings using a latent property model to obtain a first output; analyzing the second embeddings using the latent property model to obtain a second output; comparing the first embeddings, the second embeddings, and the delta value to determine a performance of the latent property model; and training the latent property model based on the performance to continue to improve the performance of the latent property model.

An example method implemented in a data processing system includes extracting symbolic property information from a training dataset by analyzing the training dataset with a symbolic property mining pipeline to extract properties of program code from one-shot program code examples, the symbolic property information indicative of types of properties of the one-shot program code examples determined to improve program code output by a large language model (LLM) in response to natural language utterances; and training a property recognition model to recognize symbolic properties associated with a natural language utterance using the training dataset and the symbolic property information, the property recognition model being configured to analyze the natural language utterance and to output the symbolic properties of program code.

An example data processing system according to the disclosure includes a processor and a memory storing executable instructions. The instructions when executed cause the processor alone or in combination with other processors to perform operations including extracting symbolic property information from a training dataset by analyzing the training dataset with a symbolic property mining pipeline to extract properties of program code from one-shot program code examples, the symbolic property information indicative of types of properties of the one-shot program code examples determined to improve program code output by a large language model (LLM) in response to natural language utterances; and training a property recognition model to recognize symbolic properties associated with a natural language utterance using the training dataset and the symbolic property information, the property recognition model being configured to analyze the natural language utterance and to output the symbolic properties of program code.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram showing examples of zero-shot and one-shot learning according to the techniques disclosed herein.

FIG. 2 is a diagram showing a latent training loop according to the techniques disclosed herein.

FIGS. 3A and 3B are diagrams of a symbolic property mining pipeline according to the techniques disclosed herein.

FIG. 4 is a diagram of a symbolic training loop according to the techniques herein.

FIG. 5 is a diagram of an example computing environment according to the techniques disclosed herein.

FIG. 6A is a flow chart of an example process for target property selection for identifying relevant program code examples to provide as an input to an LLM to improve the predictions according to the techniques disclosed herein.

FIG. 6B is a flow chart of another example process for training a model for code generation according to the techniques disclosed herein.

FIG. 7 is a block diagram showing an example software architecture, various portions of which may be used in conjunction with various hardware architectures herein described, which may implement any of the described features.

FIG. 8 is a block diagram showing components of an example machine configured to read instructions from a machine-readable medium and perform any of the features described herein.

### DETAILED DESCRIPTION

Systems and methods for target property selection for identifying relevant program code examples to provide as an input to a language model for program code generation are provided herein. These techniques solve the technical problem of identifying relevant program code examples to provide to the LLM as one-shot or few-shot examples of program code for a particular utterance. Current approaches rely on dense retrievers that compare program code examples with the utterance in embedding space. However, it is unknown whether relevant parts of the utterance and code are causing high similarities or probabilities, much less how many program code examples to select to provide to the LLM.

The techniques herein provide means for predicting which symbolic properties of the program code are relevant to providing one-shot and/or few-shot examples to the LLM for generating program code from a natural language utterance. These properties can then be used to select relevant examples from a knowledge base that includes a plurality of program code examples. A technical benefit of this approach is that it can be used to automatically identify relevant code samples that focus on specific parts of the program code that the LLM struggles with when generating program code based on a natural language utterance. Consequently, the LLM can output more accurate program code based on the natural language utterance. Another technical advantage is that this approach makes it possible to determine, based on the predict properties associated with an utterance, how many program code examples would be required to present in a one-shot or few-shot example to provide the LLM with context for all of these properties. Furthermore, the techniques herein can help to identify properties that lack sufficient examples in the knowledge base, which facilitates the addition of further examples that include one or more of these underrepresented properties. These additional examples help the LLM to generate better program code, and as a result, improves the code generation process. These and other technical benefits of the techniques disclosed herein will be evident from the discussion of the example implementations that follow.

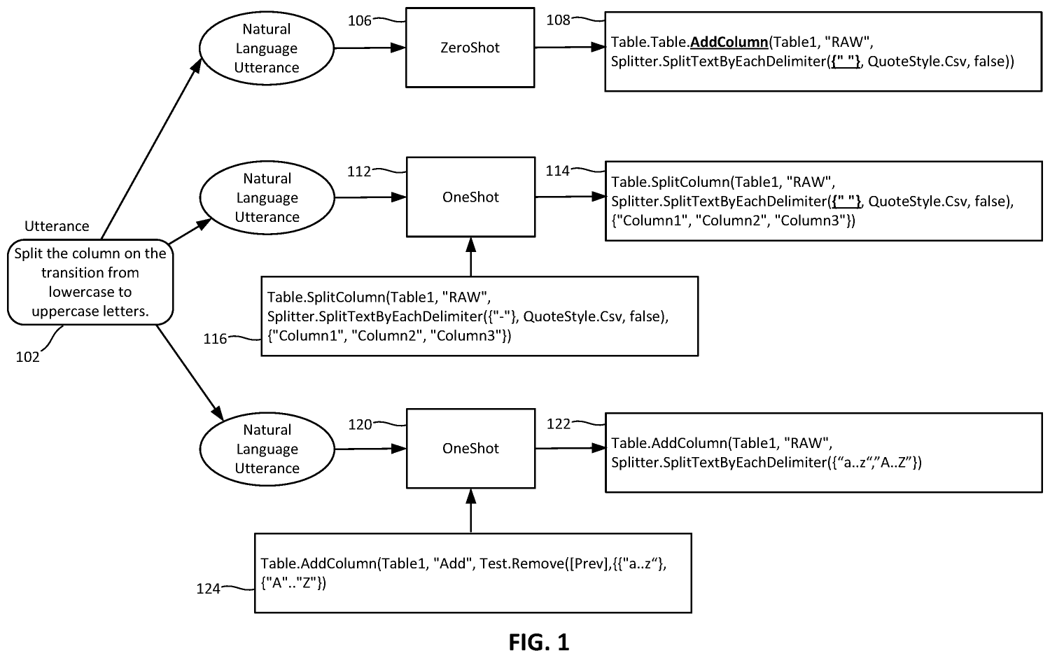

FIG. 1 is a diagram showing examples of zero-shot and one-shot predictions made by the LLM and how providing example program code to the LLM can improve the program code generated by the LLM. Such in-prompt learning is commonly used in code generation from natural language utterances to teach the LLM specific syntax or how to use specific functions by providing the LLM with relevant examples. The LLM is a generative model that is trained to receive a textual prompt and to generate a textual output in response to the prompt. The LLM may be implemented using a Generative Pre-trained Transformer (GPT) model, such as but not limited to the GPT-3 or GPT-4 models. Other implementations utilize other type of models for generating the program code from natural language utterances. FIG. 1 shows examples of problems that can arise from utilizing zero-shot and one-shot learning to generate program code from a natural language utterance, including the challenges associated with selecting the best available training examples for one-shot and/or few-shot learning.

In the example implementation shown in FIG. 1, a natural language utterance 102 is received. The natural language utterance 102 states “Split the column on the transition from lowercase to uppercase letters.” In a non-limiting example, the utterance is input or spoken by a user in an application on the user's respective client device, to cause the application to perform certain actions. In this example scenario, the natural language utterance 102 is used by the LLM to generate executable program code that is intended to cause the application to perform the actions stated in the natural language utterance 102. In the first scenario, the natural language utterance 102 is provided as an input to the LLM in a zero-shot operation 106. In zero-shot operation 106, a prompt is constructed for the LLM that instructs the LLM to generate executable program code based on the natural language utterance 102. Because this is a zero-shot operation, no training example is included with the prompt. The LLM executes the prompt and generates the output 108. The output 108 comprises executable program code generated in response to the prompt. When compared with ground truth program code that includes an example of expected correct executable program code that should have been generated in response to the natural language utterance 102, the output 108 includes a few errors. The reference to the “AddColumn” function is incorrect and the delimiter parameter of the function ‘Splitter.SplitTextByEachDelimiter ({“ ”}” is also incorrect.

In an attempt to improve the program code output by the LLM, the natural language utterance 102 is analyzed in a one-shot operation 112 in which training example 116 is included with the prompt provided to the LLM. The training example 116 provides an example of the proper syntax of the program code that performs an operation similar to that requested in the natural language utterance 102. The training example 116 may be selected from among a plurality of training examples. These examples are stored in a training data datastore, in some implementations, that includes example of labeled program code that can be used to provide context to the LLM in one-shot or few-shot examples. The LLM generates the output 114 in response to the one-shot operation 112. The one-shot or few-shot examples are included in the prompt that is constructed based on the natural language utterance 102. The output 114 is compared with the ground truth program code that should have been generated by the LLM in response to the prompt. Providing the training example 116 improves the accuracy of the program code output by the LLM. However, not all of the errors have been corrected in the program code: The parameter of the function ‘Splitter.SplitTextByEachDelimiter ({“ ”}” is still incorrect.

Another one-shot example is provided, in which the natural language utterance 102 is provided the LLM in another one-shot operation 120 with another training example 124. A prompt is constructed for the LLM based on the natural language utterance 102 and the training example 124. As can be seen in FIG. 1, the output 122 includes the correct delimiter parameter of the function ‘Splitter.SplitTextByEachDelimiter ({“a . . . z”, “A . . . Z”}” in the third example. However, the reference to the “AddColumn” is incorrect in response to this example. Thus, it is important to determine the type and number of training examples that should be included in a prompt to the LLM. The techniques provided herein help identify which properties are important when selecting training examples. Details of these techniques are provided in the examples which follow.

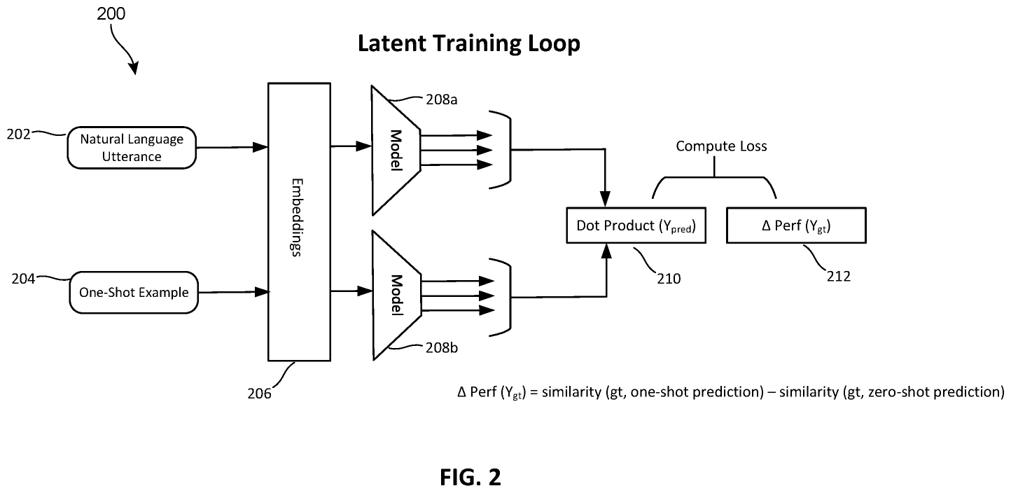

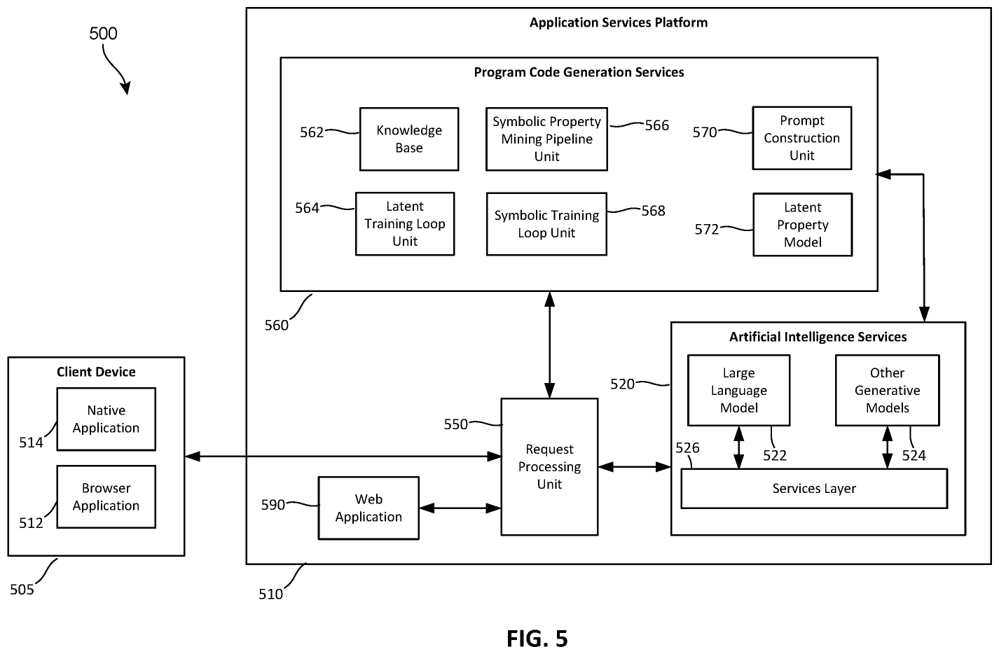

FIG. 2 is a diagram showing a latent training loop 200 according to the techniques herein. The latent training loop 200 trains a latent property model, such as the latent property model 572 shown in FIG. 5, that selects one-shot or few-shot examples for the LLM. The latent property model 572 directly compares and transforms embeddings as discussed below. The transformation is learned based on differences between zero-shot and one-shot performance for training data. In instances in which the one-shot performance is high, the similarity between the transformed embeddings of the natural language of that one-shot and the input natural language utterance should be high. The embeddings are a vector of floating-point values having dimension D, where D is a positive integer value representing a number of properties to be compared in the embeddings. A technical benefit of this approach is that is not necessary to specifically identify parts of the one-shot program code that helped to improve performance. The latent property model, once trained, can then be used to select program code examples from a knowledge base, such as the knowledge base 562 discussed in the examples which follow. These examples provide context to the LLM that help improve the predictions output by the LLM. A technical benefit of this approach is that the latent property model is used to select one-shot or few-shot examples that provide context to the LLM and consequently improve the predictions output by the LLM. Consequently, the LLM is more likely to generate syntactically correct and relevant program code that reflects the intent expressed in the natural language utterance.

The training dataset used by the latent training loop 200 to train the latent property model 572 includes training samples. The training samples include an example utterance, a one-shot example, and delta values representing whether the one-shot example improves the predictions output by the LLM. The delta value is determined by comparing (1) a zero-shot prediction compared with the ground truth with (2) a one-shot prediction compared with the ground truth to determine whether the program code generated using the one-shot program code example was more similar to the ground truth than the program code generated using the zero-shot prompt. If the one-shot prediction is closer to the ground truth than the zero-shot prediction, then one or more of the operating parameters of the latent property model modified to favor the input (the one-shot example or zero-shot example) that results in the LLM providing a better output. Additional details of how the delta value may be determined are provided below.

The natural language utterance 202 is a natural language utterance from a training dataset and the one-shot example 204 is a program code example that can be used to provide context for the LLM when constructing a prompt instructing the LLM to generate program code based on the natural language utterance 202. The training dataset may include numerous one-shot examples, and the process shown in FIG. 2 using the latent training loop 200 can be repeated for some or all of these one-shot examples to improve the performance of the latent property model 572 when suggesting the properties of examples to be selected from the knowledge base 562 for a particular natural language utterance.

In operation 206, the latent training loop 200 transforms the natural language utterance 202 to first embedding using an embeddings application programming interface (API) and transforms the one-shot example 204 to second embeddings using the embeddings API. The embeddings API is implemented by the OpenAI embeddings API in some implementations, which is configured to convert a textual input into an information dense vector of floating-point values that represent a mapping of the textual input into a latent space. Other implementations can utilize other techniques for generating the embeddings. The first embeddings are provided as an input to the latent property model 572 in operation 208a and the latent property model 572 outputs a first output based on the first embeddings. The second embeddings are provided as an input to the latent property model 572 in operation 208b and the latent property model 572 outputs a second output based on the second embeddings. The output represents a vector of floating-point values output by the latent property model that represents features of the natural language utterance that are predicted to be relevant by the latent property model 572. The second output represents a vector of floating-point values output by the latent property model 572 in response to the one-shot example. The dot-product unit 210 determines the dot product of the first output and the second output to determine a scalar value that indicates the similarity of the first output and the second output by the latent property model 572.

The latent training loop 200 computes a loss based on the scalar value output by the dot-product unit 210 and the delta value from the training sample. The loss can then be used to train the latent property model 572. In some implementations, the delta value is determined in advance by the delta performance unit 212 and include in the training dataset used by the latent training loop 200. However, in other implementations, the delta performance unit 212 determines the delta performance values as the latent training loop 200 trains the latent property model 572.

The delta performance unit 212 determines the delta value based on a one-shot prediction and a zero-shot prediction output by the LLM. The delta performance unit 212 obtains the one-shot prediction by providing the natural language utterance 202 and the one-shot example 204 as an input to the LLM. The delta performance unit 212 obtains the zero-shot prediction by providing the natural language utterance 202 as an input to the LLM. The delta value is also computing using a ground truth value that provides an example of program code that the LLM should generate in response to the natural language utterance 202. The delta value is indicative of whether the one-shot prediction was more similar to ground truth than the zero-shot prediction was to the ground truth. The one-shot prediction is the program code output by the LLM in response to a prompt based on the natural language utterance 202 and the one-shot example 204. The zero-shot prediction is the program code output by the LLM in response to a prompt based on the natural language utterance 202. The delta value is positive if the one-shot prediction was more similar to the ground truth than the zero-shot prediction. The delta value is negative if the zero-shot prediction was more similar to the ground truth than the one-shot prediction. The delta value is determined using the following equation:

ΔPerf(Y_{gt})=similarity(gt,one-shot prediction)−similarity(gt,zero-shot prediction)

Y_{gt} in the above equation represents a respective test case comprising a natural language utterance, and a ground truth program code (gt) represents the program code that should be generated for that natural language utterance, and a one-shot program code example. The similarity function quantifies the similarity between the two inputs the function. The specific similarity function used can vary from implementation to implementation. The one-shot prediction is the program code output by the LLM in response to a prompt based on the natural language utterance and the one-shot program code example, and the zero-shot prediction is the program code output by the LLM in response to a prompt based on the natural language utterance without any program code example. A positive delta value indicates that the one-shot prediction was more similar to the ground truth than the zero-shot prediction was to the ground truth. A delta value of zero indicates that the one-shot prediction is equally similar to the ground truth as the zero-shot prediction was to the ground truth. A negative delta value indicates that the one-shot prediction was less similar to the ground truth than the zero-shot prediction was to the ground truth, and thus the one-shot example resulted in the LLM generating less accurate prediction.

The latent training loop 200 computes a loss for each training example based on the dot product output by the dot product unit 210 and the delta value output by the delta performance unit 212. The delta value output offsets the dot product. The specific function used to compute the loss can vary in different implementations and the loss function may be tuned to provide optimal improvements for different implementations. The latent training loop 200 also stores the delta value computed for each training example with the training example in the training dataset in some implementations. The loss can be used to determine how the LLM is performing. A loss value of zero indicates that the zero-shot predictions are identical or nearly identical to the ground truth, while a value greater than zero indicates that the one-shot predictions were more similar to the ground truth than the zero-shot predictions. Consequently, the latent property model can be trained to select one-shot examples based on natural language utterances that are more likely to result in improved predictions output by the LLM when analyzing natural language utterances.

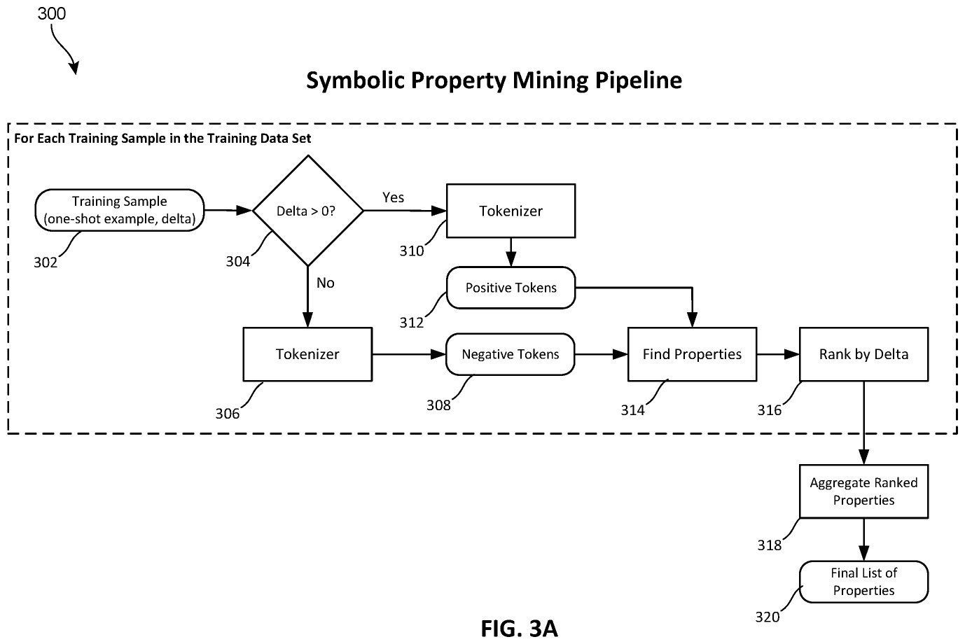

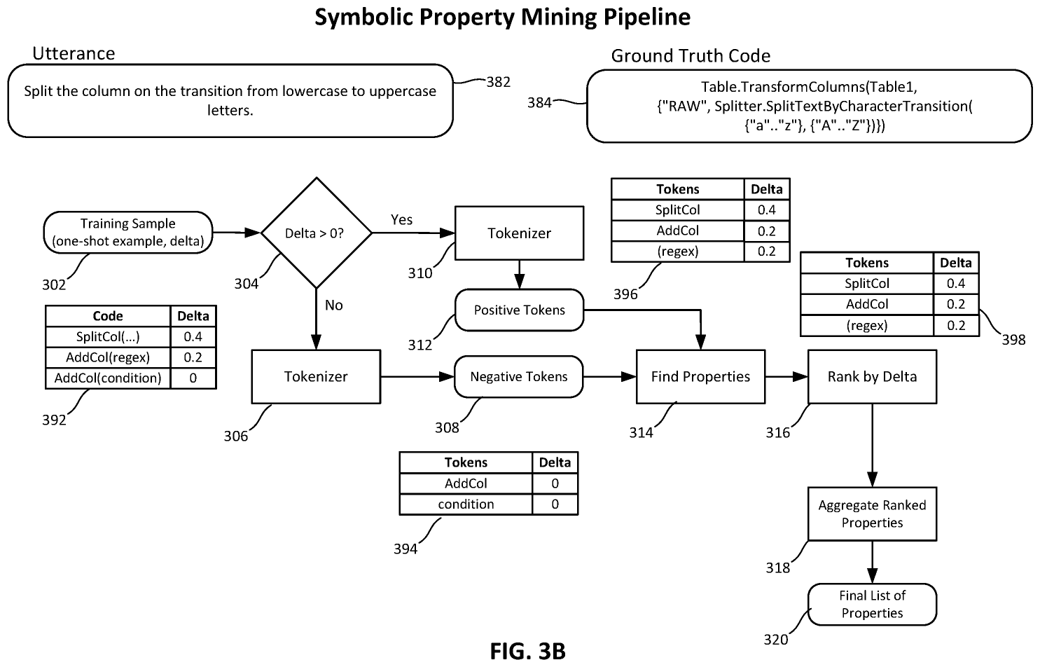

FIG. 3A shows an example of a symbolic property mining pipeline 300 that extracts relevant tokens from the natural language utterance to be used for selecting an appropriate one-shot program code example and/or few-shot program code examples for the natural language utterance. The approach taken by the symbolic property mining pipeline 300 does not make changes to the LLM itself like the latent training loop 200 shown in FIG. 2. Instead, the symbolic property mining pipeline 300 focuses on selecting appropriate one-shot and/or few-shot program code examples that are most likely to provide improvements in the program code generated by the LLM.

The training dataset used by the symbolic property mining pipeline 300 is similar to the training dataset used by the latent training loop 200 discussed above. The training dataset includes a set of training samples. Each training sample includes a natural language utterance, a ground truth program code example that provides an example of what the syntax of the program code generated by the LLM should be for that utterance, a one-shot program code example, and a delta value. The delta value for each of the training samples can be determined using the technique shown in FIG. 2, in which the zero-shot prediction, one-shot prediction, and ground truth are compared to determine whether the one-shot prediction was more similar to the ground truth than the zero-shot prediction was to the ground truth. The delta values are used by the symbolic property mining pipeline 300 to identify symbols that are relevant in the one-shot or few-shot examples that help the LLM generate better program code predictions.

The symbolic property mining pipeline 300 accesses a training sample 302 from the training dataset. The symbolic property mining pipeline 300 determines whether the delta value is greater than zero in operation 304. As discussed in the preceding examples, the delta value is positive in instances in which the one-shot prediction is more similar to the ground truth than the zero-shot prediction. This means that the one-shot program code example helped the LLM to generate program code that was closer to the ground truth than what the LLM was able to generate in response to the natural language utterance alone.

The symbolic property mining pipeline 300 proceeds to operation 306 in which the one-shot program code example is tokenized using a tokenizer responsive to the delta value being zero or less. The specific tokenizer used may depend at least in part on the model used to implement the LLM. Different models may use different tokenizers and each tokenizer may break the program code example into different sequences of characters. The tokens output by the tokenizer in operation 306 are determined to be negative tokens 308. The negative tokens 308 do not provide useful information that improve the one-shot prediction compared with the zero-shot prediction.

The symbolic property mining pipeline 300 proceeds to operation 310 in which the one-shot program code example is tokenized using the tokenizer responsive to the delta value greater than zero. The tokens output by the tokenizer in operation 306 are determined to be positive tokens 312. The positive tokens 312 provide useful information that improve the one-shot prediction compared with the zero-shot prediction.

The symbolic property mining pipeline 300 precedes to operation 314 in which the negative tokens 308 and the positive tokens 312 are combined to find properties that are relevant for the training sample 302. For any tokens appearing in both the positive tokens 312 and the negative tokens 308, the delta value associated with the negative token 308 is subtracted from the delta value associated with the positive token to determine the delta token value for that token. Any tokens having a positive delta value or cumulative token value are retained and the remaining tokens are discarded. The property mining pipeline 300 then ranks the token values based on the delta value in operation 316. Those tokens having a higher delta value are ranked higher than those tokens having a lower delta value.

In operation 318, the symbolic property mining pipeline 300 aggregates the ranked tokens with the ranked tokens obtained from analyzing the other training samples in the training dataset in operation 318. If a token already appears in the aggregated list of properties, the delta value for the training sample 302 is summed with the cumulative delta value associated with the token in the aggregated list of properties. Otherwise, the token is added to the aggregated list of properties, and the cumulative delta value is set to the delta value associated with the token. The aggregated list of properties are ranked on two factors: frequency and improvement. The frequency represents how often the token appeared in the training samples in the training dataset. For instance, the frequency would be 10 in response to the symbolic property mining pipeline 300 determining that token had a positive effect on the one-shot predictions for ten training samples. The improvement represents how much that property improved the one-shot predictions. The improvement for a particular token is the average delta of the delta values obtained for that token. For instance, the token had delta values of 0.5, 0.4, 0.6, 0.4, and 0.6 and a frequency of 5, the improvement would be 0.5, which is computed by taking the average of the delta values. The aggregated list of properties is ranked based on the frequency and the improvement. These factors are given equal weight in some implementations, while the frequency or the improvement may be weighted more heavily in other implementations.

The symbolic property mining pipeline 300 then selects a final list of properties 320 from the ranked properties. In some implementations, the property mining pipeline 300 selects the top n properties, wherein n is a positive integer. For instance, the mining pipeline 300 selects the top 100 properties in some implementations.

FIG. 3B is a diagram showing an example of the symbolic property mining pipeline 300 being applied to training samples from a training dataset. In this example, three training samples are selected from the training dataset. However, a different number of training samples can be utilized in other instances. Each training sample includes a natural language utterance 382 which includes an instruction to split a column of data on the transition from lowercase to uppercase letters. The training sample includes a ground truth program code example 384 that provides an example of the correct syntax for the program code that should be generated by the LLM based on the natural language utterance 382. The one-shot example and the delta values associated with the three one-shot examples are shown the table 392. The symbolic property mining pipeline 300 analyzes the delta values associated with the one-shot examples to generate the positive tokens 396 and the negative tokens 394. The negative tokens 394 include two tokens from the third training sample of the training samples in table 392. These tokens were added to the negative tokens 394 because the delta value associated with this training sample was zero. The positive tokens 396 include tokens from the first two training samples of the training samples in table 392. The tokens were added to the positive tokens 396 because the delta values associated with the two training samples were positive values. The positive tokens 396 and the negative tokens 394 are combined and ranked to produce the ranked properties 398. The ranked properties are then aggregated with the properties that have already been extracted from other training samples by the symbolic property mining pipeline 300 to create a final list of properties 320.

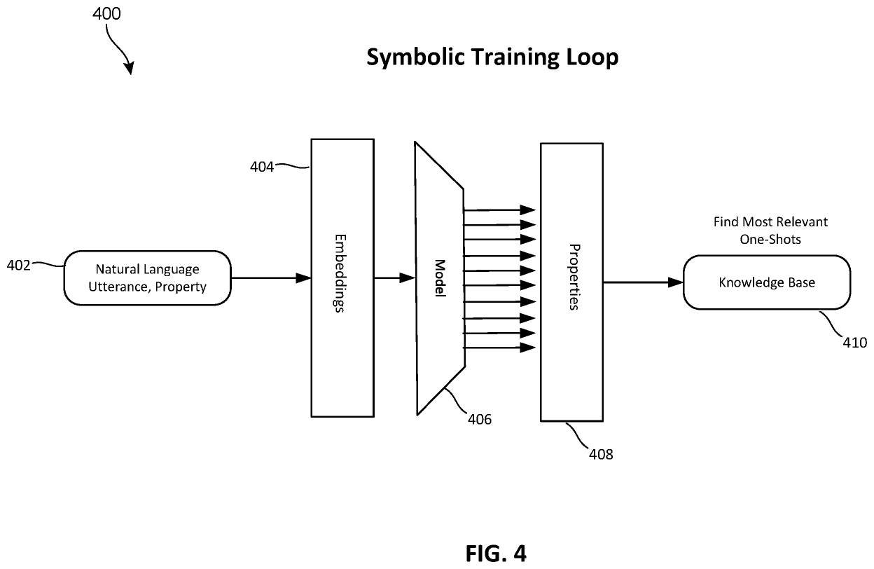

FIG. 4 is a diagram of a symbolic training loop 400 that can be used to find the most relevant one-shot examples from a knowledge base 410 that includes a set of training data. The preceding examples provided examples of a training phase in which the relevant properties of the one-shot examples provide improvements. In the example implementation shown in FIG. 4, the symbolic training loop 400 evaluates a natural language utterance 402 to determine properties 408 of the natural language utterance 402 for selecting one or more most relevant one-shot training samples of program code from the knowledge base 410. A prompt can be constructed for the LLM based on the natural language utterance 402 and one or more of the training samples identified in the knowledge based 410.

The symbolic training loop 400 transforms the natural language utterance 402 into embeddings using embeddings application programming interface API 404 that operates similar to the embeddings API discussed in the preceding examples. The symbolic training loop 400 provides the embeddings output by the embeddings API 404 as an input to the property recognition model 406. The property recognition model 406 is a neural network trained to output the properties 408 of the program code of the training examples in the knowledge base 410 that are relevant for selecting one-shot or few-shot program code examples from the knowledge base 410. The properties 408 identified by the property recognition model 406 may be found in one or more program code examples. A minimum number of program code examples can be selected that collectively cover all of the properties 408 of the natural language utterance in some implementations. These program code examples can then be included in a prompt to the LLM along with the natural language utterance to provide the LLM with relevant program code examples that have been demonstrated to show an improvement when used for one-shot and/or few-shot learning. A technical benefit of this approach is that this approach utilizes prompt construction techniques to improve the program code predictions output by the LLM without having to fine-tune the behavior of the LLM itself.

FIG. 5 is a diagram of an example computing environment 500 in which the techniques described herein are implemented. The example computing environment 500 includes a client device 505 and an application services platform 510. The application services platform 510 provides one or more cloud-based applications and/or provides services to support one or more web-enabled native applications on the client device 505. These applications may include but are not limited to design applications, communications platforms, visualization tools, collaboration tools for collaboratively creating visual representations of information, development tools, and other applications for consuming and/or creating electronic content. The client device 505 and the application services platform 510 communicate with each other over a network (not shown) or through Inter-Process Communication (IPC). The network may be a combination of one or more public and/or private networks and may be implemented at least in part by the Internet.

The application services platform 510 includes a request processing unit 550, artificial intelligence (AI) services 520, program code generation services 560, and a web application 590. The request processing unit 550 is configured to receive requests from an application implemented by the native application 514 of the client device 505, the browser application 512, and/or the web application 590 of the application services platform 510. The requests may include but are not limited to requests to generate new content, modify existing content, and/or perform other actions as discussed in the examples which follow. In some implementations, the web application 590 of the application services platform 510 implements this functionality of the design application. In other implementations, at least a portion of this functionality is implemented by the native application 514 of the client device 505. The request processing unit 550 also coordinates communication and exchange of data among components of the application services platform 510 as discussed in the examples which follow.

The program code generation services 560 implement the various techniques discussed in the preceding examples for generating program code based on natural language utterances. The knowledge base 562 is a persistent datastore that stores the training samples of the training dataset used to train the various models discussed in the preceding examples. The knowledge based 562 is also used to store the list of properties derived from the training samples in the sample dataset. The knowledge base 562 may also be used to store other information utilized by or generated by various components of the program code generation services 560. The program code generation services 560 also includes a latent training loop unit 564 which implements the latent training loop 200 shown in FIG. 2. The program code generation services 560 also implements the symbolic property mining pipeline unit 566 which implements the symbolic property mining pipeline 300 shown in FIGS. 3A and 3B. The program code generation services 560 also implements the symbolic training loop unit 568 which implements the symbolic training loop 400 shown in FIG. 4. The program code generation services 560 include a prompt construction unit 570. The prompt construction unit 570 is configured to receive a natural language utterance and to construct a prompt for the LLM 522 that causes the LLM 522 to generate program code based on the natural language utterance. The prompt construction unit 570 can also include one-shot or few-shot program code examples with the prompt to the LLM 522 to improve the program code predictions output by the LLM 522. The prompt construction unit 570 can receive the natural language utterances input by a user of the native application 514 of the client device 505 and/or the web application 590 of the application services platform 510. The latent property model 572 is a model trained by the latent training loop unit 564 as discussed in the preceding examples. The latent property model 572 is trained to analyze natural language utterances to output a transformed properties of the natural language utterances which can then be used to select relevant one-shot or few-shot examples from the knowledge base 562 to provide context to the LLM 522 to improve the code output by the LLM 522.

The AI services 520 provide various machine learning models that analyze and/or generate content. The AI services 520 include the LLM 522 and other generative models 524 in the example implementation shown in FIG. 5. The other generative models 524 may include but are not limited to models trained to generate imagery, video, audio, and/or other types of content based on natural language prompt and/or other types of input. The LLM 522 and/or the other generative models 524 provide services to the various components of the application services platform 510. The LLM 522 may be implemented using a Generative Pre-trained Transformer (GPT) model, such as but not limited to the GPT-3 or GPT-4 models. Other implementations utilize other type of models implementing the LLM 522, which is trained to generate various types of textual content in response to prompts constructed to instruct the LLM 522.

The services layer 526 receives requests to present a prompt to the models of the AI services 520 from the request processing unit 550 and/or the program code generation services 560. The prompts include natural language prompts entered by a user of the native application 514 or the web application 590. The prompts also include prompts generated by components of the program code generation services 560, including but not limited to the prompt construction unit 570. The services layer 526 formats the natural language prompts in a format that is recognized by each of the models in some implementations. The services layer 526 also routes any content generated by the models to the source of the request, which includes the program code generation services 560 or request processing unit 550.

The client device 505 is a computing device that may be implemented as a portable electronic device, such as a mobile phone, a tablet computer, a laptop computer, a portable digital assistant device, a portable game console, and/or other such devices in some implementations. The client device 505 may also be implemented in computing devices having other form factors, such as a desktop computer, vehicle onboard computing system, a kiosk, a point-of-sale system, a video game console, and/or other types of computing devices in other implementations. While the example implementation illustrated in FIG. 5 includes a single client device 505, other implementations may include a different number of client devices that utilize services provided by the application services platform 510.

The client device 505 includes a native application 514 and a browser application 512. The native application 514 is a web-enabled native application, in some implementations, implements an application that can utilize the services of the program code generation services 560 as discussed above. The browser application 512 can be used for accessing and viewing web-based content provided by the application services platform 510. In such implementations, the application services platform 510 implements one or more web applications, such as the web application 590. The application services platform 510 supports both the native application 514 and a web application 590 in some implementations, and the users may choose which approach best suits their needs.

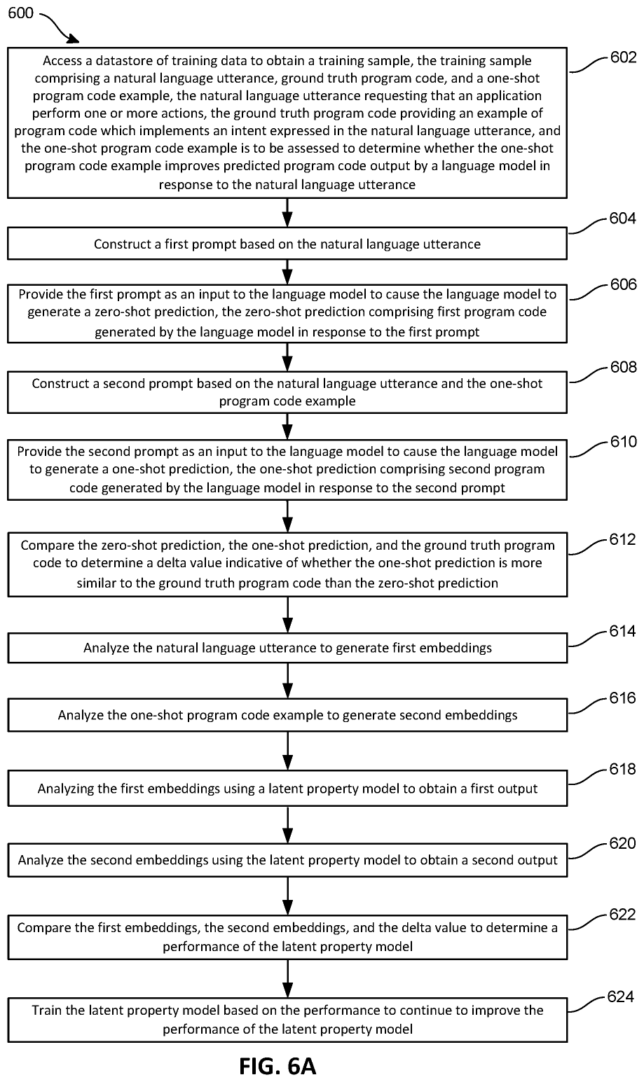

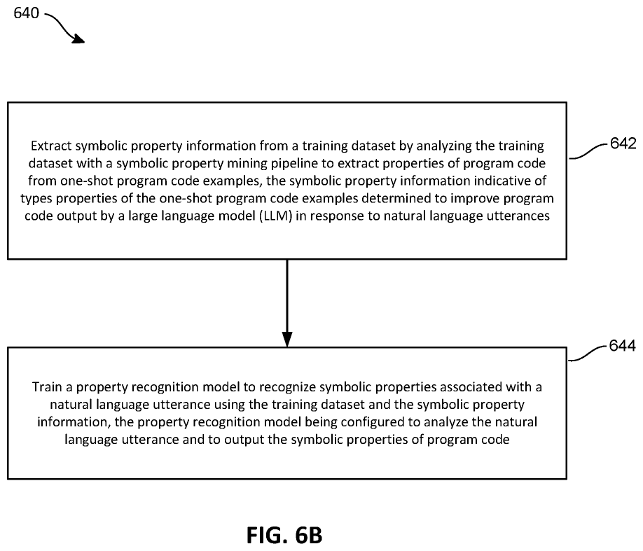

FIG. 6A is a flow chart of another example process 600 for target property selection for identifying relevant program code examples to provide as an input to an LLM to improve the predictions output by the model according to the techniques disclosed herein. The process 600 can be implemented by the latent training loop 200, the latent training loop unit 564, and/or the latent property model 572 as discussed in the preceding examples.

The process 600 includes an operation 602 of accessing a datastore of training data to obtain a training sample. The datastore may be implemented by the knowledge base 562. The latent training loop 200 can access the knowledge base 562 to obtain the training sample. The training sample includes a natural language utterance, ground truth program code, and a one-shot program code example. The natural language utterance requests that an application perform one or more actions. The ground truth program code provide an example of program code which implements an intent expressed in the natural language utterance, and the one-shot program code example is to be assessed to determine whether the one-shot program code example improves predicted program code output by a language model in response to the natural language utterance.

The process 600 includes an operation 604 of constructing a first prompt based on the natural language utterance and an operation 606 of providing the first prompt as an input to the language model to cause the language model to generate a zero-shot prediction. The zero-shot prediction comprising first program code generated by the language model in response to the first prompt. The prompt construction unit 570 constructs the first prompt and provides the prompt as an input to the LLM 522.

The process 600 includes an operation 608 of constructing a second prompt based on the natural language utterance and the one-shot program code example and an operation 610 of providing the second prompt as an input to the language model to cause the language model to generate a one-shot prediction. The one-shot prediction includes second program code generated by the language model in response to the second prompt. The prompt construction unit 570 constructs the second prompt and provides the prompt as an input to the LLM 522.

The process 600 includes an operation 612 of comparing the zero-shot prediction, the one-shot prediction, and the ground truth program code to determine a delta value indicative of whether the one-shot prediction is more similar to the ground truth program code than the zero-shot prediction. The delta performance unit 212 determines the delta value based on a one-shot prediction and a zero-shot prediction output by the LLM 522 as discussed with respect to FIG. 2.

The process 600 includes an operation 614 of analyzing the natural language utterance to generate first embeddings and an operation 616 of analyzing the one-shot program code example to generate second embeddings. The latent training loop 200 transforms the natural language utterance 202 to first embedding using an embeddings API and transforms the one-shot example 204 to second embeddings using the embeddings API.

The process 600 includes an operation 618 of analyzing the first embeddings using a latent property model 572 to obtain a first output and an operation 620 of analyzing the second embeddings using the latent property model 572 to obtain a second output.

The process 600 includes an operation 622 of comparing the first embeddings, the second embeddings, and the delta value to determine a performance of the latent property model. As discussed in the preceding examples, the dot product unit 210 of the latent training loop 200 compares the output of the latent property model 572 in response to analyzing the embeddings of the natural language utterance 202 and the output of the latent property model 572 in response analyzing the embeddings of the one-shot example 204.

The process 600 includes an operation 624 of training the latent property model based on the performance to continue to improve the performance of the latent property model 572. The latent training loop 200 continues to train the latent property model 572 based on the loss determined by the latent training loop 200.

FIG. 6B is a flow chart of another example process 640 for training a model for code generation according to the techniques disclosed herein. The process 640 can be implemented by the program code generation services 560 shown in the preceding examples, the symbolic property mining pipeline 300 and/or the symbolic training loop 400.

The process 600 includes an operation 642 of extracting symbolic property information from a training dataset by analyzing the training dataset with a symbolic property mining pipeline to extract properties of program code from one-shot program code examples. The symbolic property information indicative of types of properties of the one-shot program code examples determined to improve program code output by a large language model (LLM) in response to natural language utterances. The operation 642 can be performed by the symbolic property mining pipeline 300 shown in FIGS. 3A and 3B.

The process 600 includes an operation 644 of training a property recognition model to recognize symbolic properties associated with a natural language utterance using the training dataset and the symbolic property information. The property recognition model being configured to analyze the natural language utterance and to output the symbolic properties of program code. The symbolic training loop 400 can perform the operation 644. The symbolic training loop 400 trains the property recognition model, which can then be used to identify relevant properties based on natural language utterances requesting that the LLM generate program code. The natural language utterances may be received from the native application 514 and/or the web application 590 in some implementations. The program code generation services 560 uses the symbolic properties predicted to be relevant by the property recognition model to select one or more relevant program code examples from the knowledge base 562. The prompt construction unit 570 constructs a prompt for the LLM 522 based on the natural language utterance and the one or more relevant program code examples.

The detailed examples of systems, devices, and techniques described in connection with FIGS. 1-6B are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-6B are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

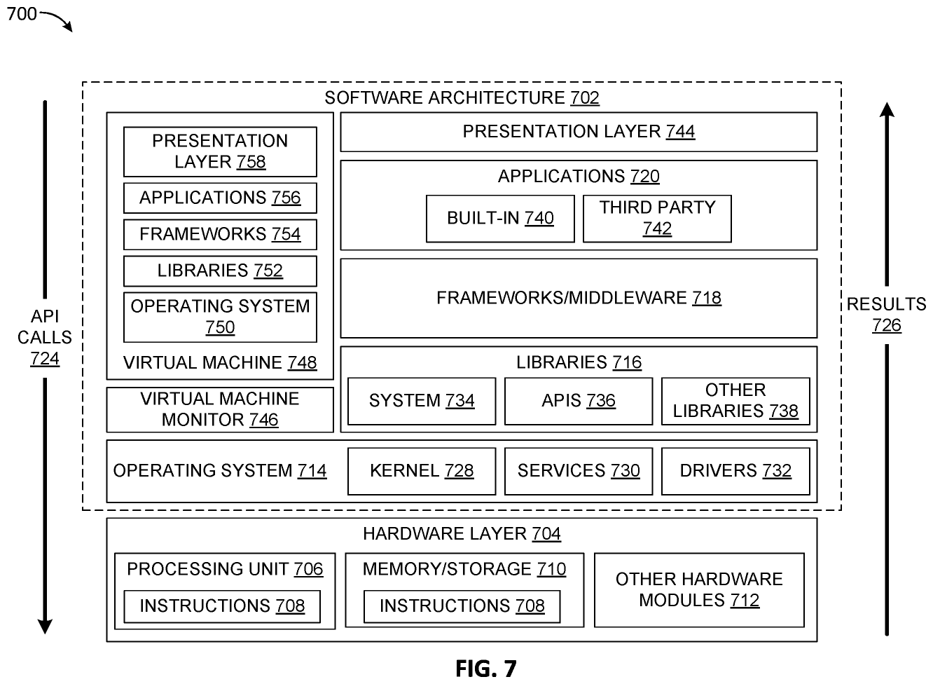

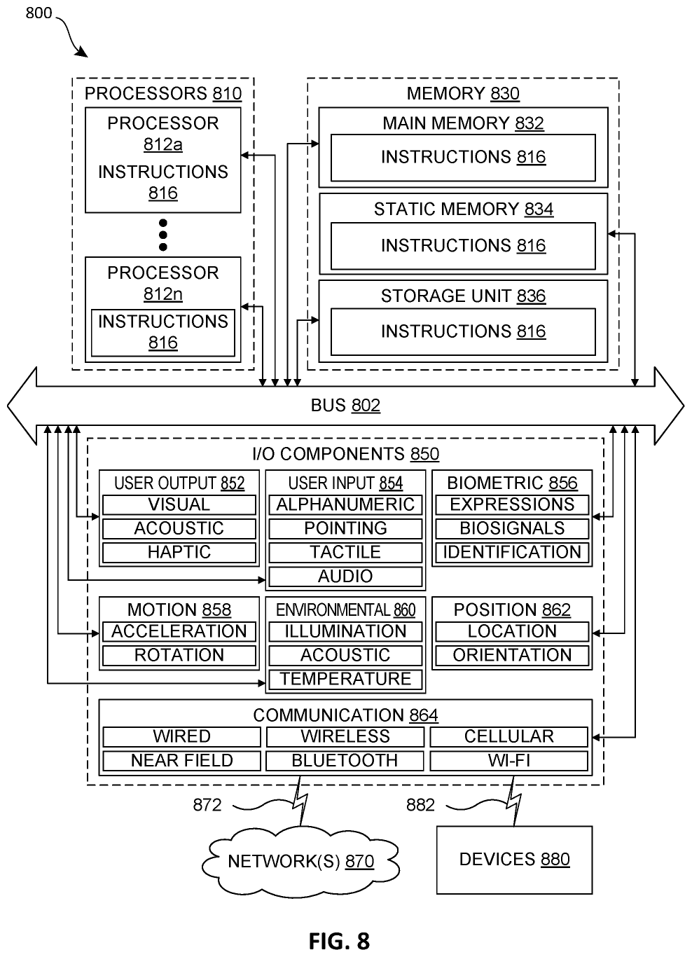

FIG. 7 is a block diagram 700 illustrating an example software architecture 702, various portions of which may be used in conjunction with various hardware architectures herein described, which may implement any of the above-described features. FIG. 7 is a non-limiting example of a software architecture, and it will be appreciated that many other architectures may be implemented to facilitate the functionality described herein. The software architecture 702 may execute on hardware such as a machine 800 of FIG. 8 that includes, among other things, processors 810, memory 830, and input/output (I/O) components 850. A representative hardware layer 704 is illustrated and can represent, for example, the machine 800 of FIG. 8. The representative hardware layer 704 includes a processing unit 706 and associated executable instructions 708. The executable instructions 708 represent executable instructions of the software architecture 702, including implementation of the methods, modules and so forth described herein. The hardware layer 704 also includes a memory/storage 710, which also includes the executable instructions 708 and accompanying data. The hardware layer 704 may also include other hardware modules 712. Instructions 708 held by processing unit 706 may be portions of instructions 708 held by the memory/storage 710.

The example software architecture 702 may be conceptualized as layers, each providing various functionality. For example, the software architecture 702 may include layers and components such as an operating system (OS) 714, libraries 716, frameworks/middleware 718, applications 720, and a presentation layer 744. Operationally, the applications 720 and/or other components within the layers may invoke API calls 724 to other layers and receive corresponding results 726. The layers illustrated are representative in nature and other software architectures may include additional or different layers. For example, some mobile or special purpose operating systems may not provide the frameworks/middleware 718.

The OS 714 may manage hardware resources and provide common services. The OS 714 may include, for example, a kernel 728, services 730, and drivers 732. The kernel 728 may act as an abstraction layer between the hardware layer 704 and other software layers. For example, the kernel 728 may be responsible for memory management, processor management (for example, scheduling), component management, networking, security settings, and so on. The services 730 may provide other common services for the other software layers. The drivers 732 may be responsible for controlling or interfacing with the underlying hardware layer 704. For instance, the drivers 732 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 716 may provide a common infrastructure that may be used by the applications 720 and/or other components and/or layers. The libraries 716 typically provide functionality for use by other software modules to perform tasks, rather than interacting directly with the OS 714. The libraries 716 may include system libraries 734 (for example, C standard library) that may provide functions such as memory allocation, string manipulation, file operations. In addition, the libraries 716 may include API libraries 736 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 716 may also include a wide variety of other libraries 738 to provide many functions for applications 720 and other software modules.

The frameworks/middleware 718 provide a higher-level common infrastructure that may be used by the applications 720 and/or other software modules. For example, the frameworks/middleware 718 may provide various graphic user interface (GUI) functions, high-level resource management, or high-level location services. The frameworks/middleware 718 may provide a broad spectrum of other APIs for applications 720 and/or other software modules.

The applications 720 include built-in applications 740 and/or third-party applications 742. Examples of built-in applications 740 may include, but are not limited to, a contacts application, a browser application, a location application, a media application, a messaging application, and/or a game application. Third-party applications 742 may include any applications developed by an entity other than the vendor of the particular platform. The applications 720 may use functions available via OS 714, libraries 716, frameworks/middleware 718, and presentation layer 744 to create user interfaces to interact with users.

Some software architectures use virtual machines, as illustrated by a virtual machine 748. The virtual machine 748 provides an execution environment where applications/modules can execute as if they were executing on a hardware machine (such as the machine 800 of FIG. 8, for example). The virtual machine 748 may be hosted by a host OS (for example, OS 714) or hypervisor, and may have a virtual machine monitor 746 which manages operation of the virtual machine 748 and interoperation with the host operating system. A software architecture, which may be different from software architecture 702 outside of the virtual machine, executes within the virtual machine 748 such as an OS 750, libraries 752, frameworks 754, applications 756, and/or a presentation layer 758.

FIG. 8 is a block diagram illustrating components of an example machine 800 configured to read instructions from a machine-readable medium (for example, a machine-readable storage medium) and perform any of the features described herein. The example machine 800 is in a form of a computer system, within which instructions 816 (for example, in the form of software components) for causing the machine 800 to perform any of the features described herein may be executed. As such, the instructions 816 may be used to implement modules or components described herein. The instructions 816 cause unprogrammed and/or unconfigured machine 800 to operate as a particular machine configured to carry out the described features. The machine 800 may be configured to operate as a standalone device or may be coupled (for example, networked) to other machines. In a networked deployment, the machine 800 may operate in the capacity of a server machine or a client machine in a server-client network environment, or as a node in a peer-to-peer or distributed network environment. Machine 800 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 800 is illustrated, the term “machine” includes a collection of machines that individually or jointly execute the instructions 816.

The machine 800 may include processors 810, memory/storage 830, and I/O components 850, which may be communicatively coupled via, for example, a bus 802. The bus 802 may include multiple buses coupling various elements of machine 800 via various bus technologies and protocols. In an example, the processors 810 (including, for example, a central processing unit (CPU), a graphics processing unit (GPU), a digital signal processor (DSP), an ASIC, or a suitable combination thereof) may include one or more processors 812a to 812n that may execute the instructions 816 and process data. In some examples, one or more processors 810 may execute instructions provided or identified by one or more other processors 810. The term “processor” includes a multicore processor including cores that may execute instructions contemporaneously. Although FIG. 8 shows multiple processors, the machine 800 may include a single processor with a single core, a single processor with multiple cores (for example, a multicore processor), multiple processors each with a single core, multiple processors each with multiple cores, or any combination thereof. In some examples, the machine 800 may include multiple processors distributed among multiple machines.

The memory/storage 830 may include a main memory 832, a static memory 834, or other memory, and a storage unit 836, both accessible to the processors 810 such as via the bus 802. The storage unit 836 and memory 832, 834 store instructions 816 embodying any one or more of the functions described herein. The memory/storage 830 may also store temporary, intermediate, and/or long-term data for processors 810. The instructions 816 may also reside, completely or partially, within the memory 832, 834, within the storage unit 836, within at least one of the processors 810 (for example, within a command buffer or cache memory), within memory at least one of I/O components 850, or any suitable combination thereof, during execution thereof. Accordingly, the memory 832, 834, the storage unit 836, memory in processors 810, and memory in I/O components 850 are examples of machine-readable media.

As used herein, “machine-readable medium” refers to a device able to temporarily or permanently store instructions and data that cause machine 800 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 816) for execution by a machine 800 such that the instructions, when executed by one or more processors 810 of the machine 800, cause the machine 800 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 850 may include a wide variety of hardware components adapted to receive input, provide output, produce output, transmit information, exchange information, capture measurements, and so on. The specific I/O components 850 included in a particular machine will depend on the type and/or function of the machine. For example, mobile devices such as mobile phones may include a touch input device, whereas a headless server or IoT device may not include such a touch input device. The particular examples of I/O components illustrated in FIG. 8 are in no way limiting, and other types of components may be included in machine 800. The grouping of I/O components 850 are merely for simplifying this discussion, and the grouping is in no way limiting. In various examples, the I/O components 850 may include user output components 852 and user input components 854. User output components 852 may include, for example, display components for displaying information (for example, a liquid crystal display (LCD) or a projector), acoustic components (for example, speakers), haptic components (for example, a vibratory motor or force-feedback device), and/or other signal generators. User input components 854 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 850 may include biometric components 856, motion components 858, environmental components 860, and/or position components 862, among a wide array of other physical sensor components. The biometric components 856 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 858 may include, for example, acceleration sensors (for example, an accelerometer) and rotation sensors (for example, a gyroscope). The environmental components 860 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 862 may include, for example, location sensors (for example, a Global Position System (GPS) receiver), altitude sensors (for example, an air pressure sensor from which altitude may be derived), and/or orientation sensors (for example, magnetometers).

The I/O components 850 may include communication components 864, implementing a wide variety of technologies operable to couple the machine 800 to network(s) 870 and/or device(s) 880 via respective communicative couplings 872 and 882. The communication components 864 may include one or more network interface components or other suitable devices to interface with the network(s) 870. The communication components 864 may include, for example, components adapted to provide wired communication, wireless communication, cellular communication, Near Field Communication (NFC), Bluetooth communication, Wi-Fi, and/or communication via other modalities. The device(s) 880 may include other machines or various peripheral devices (for example, coupled via USB).

In some examples, the communication components 864 may detect identifiers or include components adapted to detect identifiers. For example, the communication components 864 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 864, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a memory storing executable instructions that, when executed, cause the processor alone or in combination with other processors to perform operations of:
accessing a datastore of training data to obtain a training sample, the training sample comprising a natural language utterance, ground truth program code, and a one-shot program code example, the natural language utterance requesting that an application perform one or more actions, the ground truth program code providing an example of program code which implements an intent expressed in the natural language utterance, and the one-shot program code example is to be assessed to determine whether the one-shot program code example improves predicted program code output by a language model in response to the natural language utterance;
constructing a first prompt based on the natural language utterance;
providing the first prompt as an input to the language model to cause the language model to generate a zero-shot prediction, the zero-shot prediction comprising first program code generated by the language model in response to the first prompt;
constructing a second prompt based on the natural language utterance and the one-shot program code example;
providing the second prompt as an input to the language model to cause the language model to generate a one-shot prediction, the one-shot prediction comprising second program code generated by the language model in response to the second prompt;
comparing the zero-shot prediction, the one-shot prediction, and the ground truth program code to determine a delta value indicative of whether the one-shot prediction is more similar to the ground truth program code than the zero-shot prediction;
analyzing the natural language utterance to generate first embeddings;
analyzing the one-shot program code example to generate second embeddings;
analyzing the first embeddings using a latent property model to obtain a first output;
analyzing the second embeddings using the latent property model to obtain a second output;
comparing the first embeddings, the second embeddings, and the delta value to determine a performance of the latent property model; and
training the latent property model based on the performance to continue to improve the performance of the latent property model.

2. The data processing system of claim 1, wherein comparing the zero-shot prediction, the one-shot prediction, and the ground truth program code to determine the delta value further comprises:
comparing the one-shot prediction with the ground truth program code to determine a first ground truth similarity value;
comparing the zero-shot prediction with the ground truth program code to determine a second ground truth similarity value; and
subtracting the second ground truth similarity value from the first ground truth similarity value to determine the delta value.

3. The data processing system of claim 2, wherein comparing the first embeddings, the second embeddings, and the delta value to determine the performance of the latent property model further comprises:
determining a dot product of the first output and the second output to obtain a scalar value representing a similarity of the one-shot prediction and the zero-shot prediction.

4. The data processing system of claim 3, wherein the memory further includes instructions configured to cause the processor alone or in combination with other processors to perform operations of:
computing a loss based on the scalar value and the delta value.

5. The data processing system of claim 1, wherein the memory further includes instructions configured to cause the processor alone or in combination with other processors to perform operations of:
receiving a request from an application that includes a second natural language utterance, the second natural language utterance comprising instructions to be performed by the application;
analyzing the second natural language utterance using the latent property model to obtain a third output;
selecting a second one-shot example program code from a knowledge base based on the third output;
constructing a prompt based on the second natural language utterance and the second one-shot example program code;
providing the prompt as an input to the language model to cause the language model to generate executable program code; and
causing the executable program code to be executed to cause the application to perform the instructions included in the second natural language utterance.

6. The data processing system of claim 1, wherein the language model is implemented using a Generative Pre-trained Transformer (GPT) model.

7. A data processing system comprising:
a processor; and
a memory storing executable instructions that, when executed, cause the processor alone or in combination with other processors to perform operations of:
extracting symbolic property information from a training dataset by analyzing the training dataset with a symbolic property mining pipeline to extract properties of program code from one-shot program code examples, the symbolic property information indicative of types of properties of the one-shot program code examples determined to improve program code output by a large language model (LLM) in response to natural language utterances; and
training a property recognition model to recognize symbolic properties associated with a natural language utterance using the training dataset and the symbolic property information, the property recognition model being configured to analyze the natural language utterance and to output the symbolic properties of program code.

8. The data processing system of claim 7, wherein the training dataset includes a plurality of training samples, and wherein each training sample comprises a natural language utterance, ground truth program code, and a one-shot program code example, and a delta value, the natural language utterance requesting that an application perform one or more actions, the ground truth program code providing an example of program code which implements an intent expressed in the natural language utterance, and the one-shot program code example, and the delta value being indicative of whether the one-shot program code example improved the program code output by the LLM in response to the natural language utterance.

9. The data processing system of claim 8, wherein the memory further includes instructions configured to cause the processor alone or in combination with other processors to perform, for a training sample in the training dataset, operations of:
generating a set of tokens by tokenizing the one-shot program code example associated with the training sample; and
adding the set of tokens and the delta value associated with the one-shot program code example to a set of positive tokens responsive to the delta value being greater than zero.

10. The data processing system of claim 9, wherein the memory further includes instructions configured to cause the processor alone or in combination with other processors to perform, for a training sample in the training dataset, operations of:
aggregating the set of positive tokens from all of the plurality of training samples into an aggregated set of tokens; and
ranking the aggregated set of tokens based on the delta value associated with each token to create the symbolic property information indicative.

11. The data processing system of claim 7, wherein the memory further includes instructions configured to cause the processor alone or in combination with other processors to perform operations of:
receiving a request from an application that includes a first natural language utterance, the first natural language utterance comprising instructions to be performed by the application;
analyzing the first natural language utterance using the property recognition model to obtain first symbolic property information;
selecting one or more program code examples from a training dataset based on the first symbolic property information;
constructing a first prompt for the LLM based on the first natural language utterance and the one or more program code examples; and
providing the first prompt as an input to the LLM to cause the LLM to generate first executable program code.

12. The data processing system of claim 11, wherein the memory further includes instructions configured to cause the processor alone or in combination with other processors to perform operations of:
providing the first executable program code to the application; and
causing the application to execute the first executable program code.

13. The data processing system of claim 12, wherein selecting the one or more program code examples from a training dataset based on the first symbolic property information further comprises selecting a minimum number of program code examples to include a program code example for each token included in the first symbolic property information.

14. The data processing system of claim 7, wherein the LLM is implemented using a Generative Pre-trained Transformer (GPT) model.

15. A method implemented in a data processing system for training a model for code generation, the method comprising:
extracting symbolic property information from a training dataset by analyzing the training dataset with a symbolic property mining pipeline to extract properties of program code from one-shot program code examples, the symbolic property information indicative of types of properties of the one-shot program code examples determined to improve program code output by a large language model (LLM) in response to natural language utterances; and
training a property recognition model to recognize symbolic properties associated with a natural language utterance using the training dataset and the symbolic property information, the property recognition model being configured to analyze the natural language utterance and to output the symbolic properties of program code.

16. The method of claim 15, wherein the training dataset includes a plurality of training samples, and wherein each training sample comprises a natural language utterance, ground truth program code, and a one-shot program code example, and a delta value, the natural language utterance requesting that an application perform one or more actions, the ground truth program code providing an example of program code which implements an intent expressed in the natural language utterance, and the one-shot program code example, and the delta value being indicative of whether the one-shot program code example improved the program code output by the LLM in response to the natural language utterance.

17. The method of claim 16, wherein, for a training sample in the training dataset, the method further comprises:
generating a set of tokens by tokenizing the one-shot program code example associated with the training sample; and
adding the set of tokens and the delta value associated with the one-shot program code example to a set of positive tokens responsive to the delta value being greater than zero.

18. The method of claim 17, further comprising, for a training sample in the training dataset, operations of:
aggregating the set of positive tokens from all of the plurality of training samples into an aggregated set of tokens; and
ranking the aggregated set of tokens based on the delta value associated with each token to create the symbolic property information indicative.

19. The method of claim 15, further comprising:
receiving a request from an application that includes a first natural language utterance, the first natural language utterance comprising instructions to be performed by the application;
analyzing the first natural language utterance using the property recognition model to obtain first symbolic property information;
selecting one or more program code examples from a training dataset based on the first symbolic property information;
constructing a first prompt for the LLM based on the first natural language utterance and the one or more program code examples; and
providing the first prompt as an input to the LLM to cause the LLM to generate first executable program code.

20. The method of claim 19, further comprising:
providing the first executable program code to the application; and
causing the application to execute the first executable program code.
